(19) United States
(12) Patent Application Publication
(10) Pub. No.: US 2004/0182742 A1
(43) Pub. Date: Sep. 23, 2004

(54) Method and bracing system for packaging circuit boards

(76) Inventors: Rick L. Bontrager, Ripon, CA (US); Thomas Stephens, Los Gatos, CA (US); James R. Skinner, Aptos, CA (US)

Correspondence Address: Martin C. Fliesler, FLIESLER DUBB MEYER & LOVEJOY LLP, Four Embarcadero Center, Fourth Floor, San Francisco, CA, 94111-4156, US

(21) Appl. No.: 10/390,251

(22) Filed: Mar. 17, 2003

(51) Int. Cl. B67B 5/00; B65D 85/30

(52) U.S. Cl. 206/706; 53/471

(57) ABSTRACT

Methods and bracing systems for packaging circuit boards and other articles in accordance with the present invention dampen shocks and/or vibrations during shipping and storage, while avoiding the use of voluminous packaging materials commonly used for such tasks. A bracing system in accordance with one embodiment uses two load-bearing braces that can be connected with a circuit board and locked in place by a tray and lid. The brace system dampens shock and/or vibration, protecting sensitive, otherwise exposed components. This description is not intended to be a complete description of, or limit the scope of, the invention. Other features, aspects, and objects of the invention can be obtained from a review of the specification, the figures, and the claims.

### TECHNICAL FIELD

The present invention relates to packaging used for shipping shock and/or vibration sensitive articles.

### BACKGROUND

Circuit boards, hard disk drives, consumer electronics, and other shock and/or vibration sensitive articles require special packaging material when shipped inside cartons. Commonly, packaging material used to protect such sensitive articles includes expandable polyethylene, polystyrene Bubble Wrap®, polyurethane, styro-foam peanuts, preformed polystyrene foam or beads, preformed paperboard, etc. Ideally, the packaging material absorbs and dissipates shocks and vibrations impinging the shipping carton to minimize the shocks and vibrations experienced by sensitive articles.

In order for commonly used packaging materials to minimize shock and vibration, large volumes of packaging material are used to envelop and cushion the sensitive article. Voluminous packaging material is expensive and takes up excessive space before and after use. Further, voluminous packaging material necessitates larger shipping cartons, compounding the cost of shipping. The shock/vibration dissipation performance of commonly used packaging materials can depend on how the user packages the sensitive article. If the commonly used packaging material provides inadequate protection, the only way to adjust dissipation performance is to add more packaging material, consequently increasing the shipping carton size.

Alternatively, unitary packaging structures made of flexible polymeric materials allow shock and vibration to dissipate through flexing of the structure walls. U.S. Pat. Nos. 5,226,543, 5,385,232 and 5,515,976 disclose examples of unitary packaging structures. These unitary packaging structures dissipate shocks primarily in only one direction and can fail to provide adequate shock and vibration protection. U.S. Pat. No. 5,799,796 discloses an alternative unitary packaging structure for dissipating shock and vibrations that can provide improved shock and vibration protection and can be adjusted for more or less dampening.

Many sensitive articles can vary widely in size and shape, making them difficult to package. For example, circuit boards can vary in layout, and in the number and size of components soldered, or connected with the board (and thus potentially protruding from the board).

### BRIEF DESCRIPTION OF THE FIGURES

Further details of embodiments of the present invention are explained with the help of the attached drawings in which:

FIG. 1A is an partially exploded view of a bracing system in accordance with one embodiment of the present invention;

FIG. 1B is a perspective view of the bracing system of FIG. 1A, showing braces having support surfaces positioned above an article;

FIG. 2A is a plan view of a tray for the bracing system of FIG. 1 in accordance with one embodiment of the present invention;

FIG. 2B is a side view of the tray of FIG. 1A;

FIG. 3A is a plan view of a lid for the bracing system of FIG. 1 in accordance with one embodiment of the present invention;

FIG. 3B is a side view of the lid of FIG. 2A;

FIG. 4A is a perspective view of a brace for the bracing system of FIG. 1 in accordance with one embodiment of the present invention;

FIG. 4B is a cross-section of the brace of FIG. 3A;

FIG. 4C is a perspective view of the brace of FIG. 3A positioned to be connected with a circuit board;

FIG. 4D is a cross-section of a brace in accordance with an alternative embodiment of the present invention;

FIG. 4E is across-section of a brace in accordance with a second alternative embodiment of the present invention;

FIG. 4F is a cross-section of a brace for packaging two circuit boards in accordance with another embodiment of the present invention; and

FIG. 5 is a cross-section of the bracing system of FIG. 1.

### DETAILED DESCRIPTION

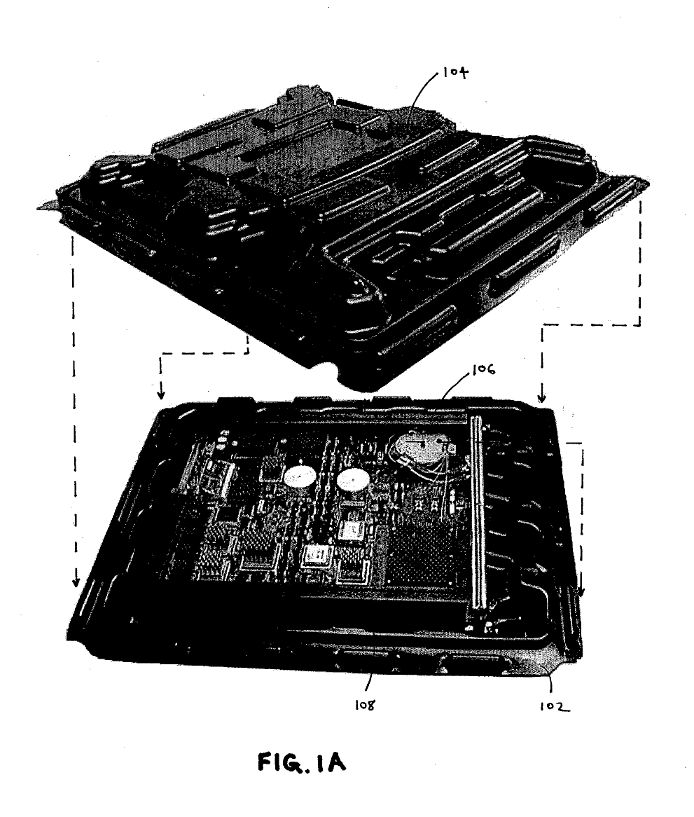

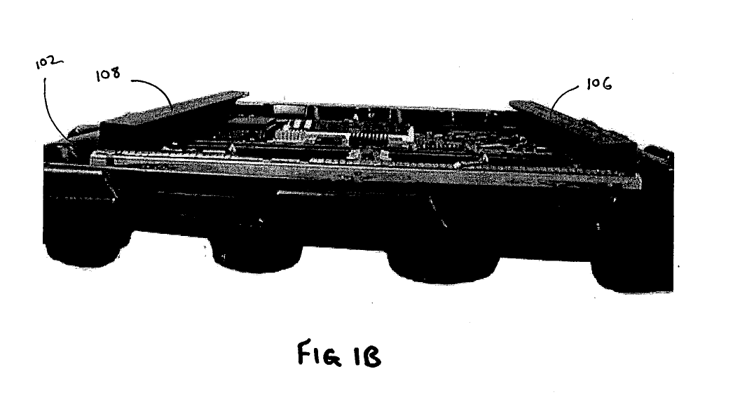

FIGS. 1A-5 illustrate one embodiment of a bracing system for packaging circuit boards in accordance with the present invention. As shown in FIG. 1A, the bracing system 100 comprises a tray 102 for supporting an article (a circuit board as shown), a first brace 106 and a second brace 108 removably connected with the article for supporting a vertical load, and a lid 104 connected with the tray 102. The braces 106, 108 can be removably connected with opposite sides of the circuit board such that the braces 106, 108 have a longitudinal dimension perpendicular to a front bezel of the circuit board. As shown in FIG. 1B, when the circuit board lies flat within a recess of the tray 102 the braces 106, 108 extend vertically so that load bearing surfaces of the braces 106, 108 are positioned above electrical and mechanical components connected with the circuit board, allowing the braces 106, 108 to support a load applied to the lid 104. A method for packaging circuit boards utilizing the bracing system 100 in accordance with one embodiment of the present invention can protect circuit boards or other articles from damage from shock and/or vibrations.

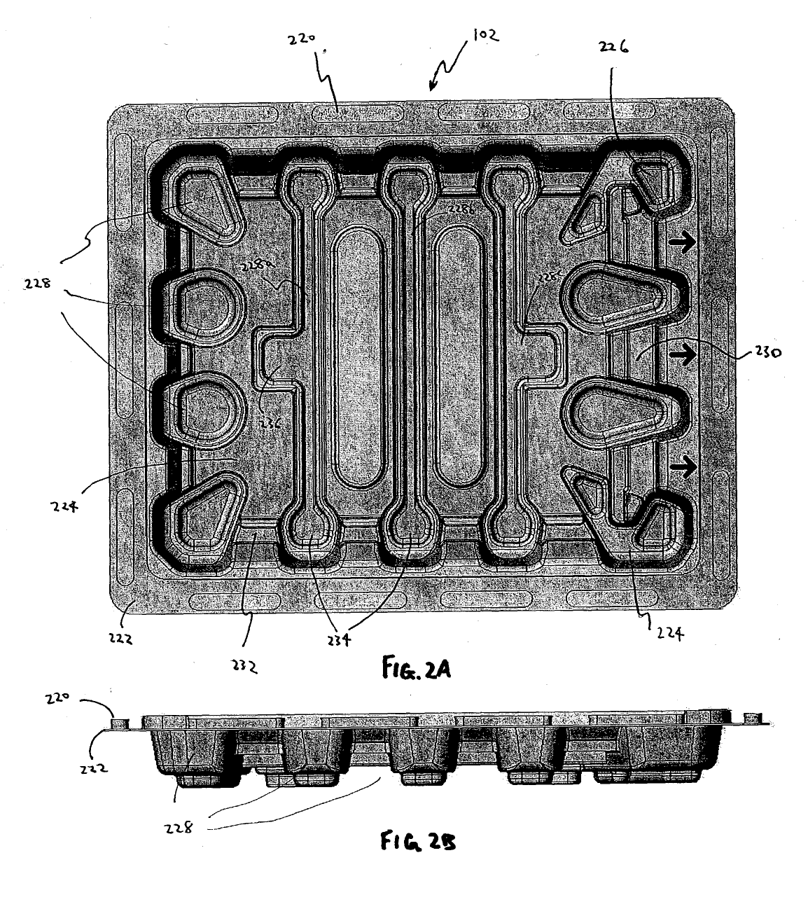

FIG. 2A is a plan view and FIG. 2B is a side view of the tray 102 of FIG. 1 for supporting a circuit board in accordance with one embodiment of the present invention. The tray 102 can include a lip 222 along the periphery of the tray 102, and a recessed base 224 within the tray 102. The lip 222 can include male snaps 220 (shown in FIG. 2B protruding from the lip) and/or female snaps for mating with female and/or male snaps of the lid 104. In other embodiments, the tray 102 does not include a lip 222. In still other embodiments, the tray 102 and lid 104 are extruded or formed as a single piece having a hinge such that the tray 102 and lid 104 form a clamshell. One of ordinary skill in the art can appreciate the myriad of different configurations for connecting the tray 102 with the lid 104 such that an article can be contained between the tray 102 and lid 104.

As shown in FIG. 2A, the tray 102 can include a front portion having load-bearing corners 226 for supporting a bezel of the circuit board and one or more step structures 230 within the recessed base 224 abutting the bezel to prevent the circuit board from shifting forward in the tray 102. The load-bearing corners 226 can be bulbous in shape so that the corners 226 can be partially crushed without contacting sharp corners of the front bezel, thereby avoiding piercing of the tray 102. The recessed base 224 further includes at least one lateral step structure 232 on each side of the tray 102 for supporting the braces 106, 108 (and by extension the circuit board) such that the circuit board can be suspended over the recessed base 224 and a plurality of collapsible structures 228 for dampening shock and/or vibrations. FIG. 2A illustrates three such collapsible structures 228a-c formed along a transverse axis between the two sides of the tray 230. The center transverse structure 228b is further recessed from the base 224 and can have perpendicular sidewalls, thus forming a narrow trench. If shock and/or vibration impacts the front or rear of the tray 102, the center transverse structure 228b can absorb the shock and/or vibration by collapsing the narrow trench such that the sidewalls of the trench deform, and the gap created by the narrow trench closes slightly. Further, the other two transverse structures 228a, 228c can also be recessed from the base 224 and can further include a lateral bulge 236 so that the transverse structures 228a, 228c can absorb oblique shocks and/or vibrations. The collapsible structures 228 can have a variety of different geometries and can be designed to protect against impact from particular angles or sources. In other embodiments, the tray 104 can have additional or fewer collapsible structures 228. In still other embodiments, the tray 104 need not have any collapsible structures 228. One of ordinary skill in the art can appreciable the myriad of different configurations and arrangements with which the tray 104 can be formed.

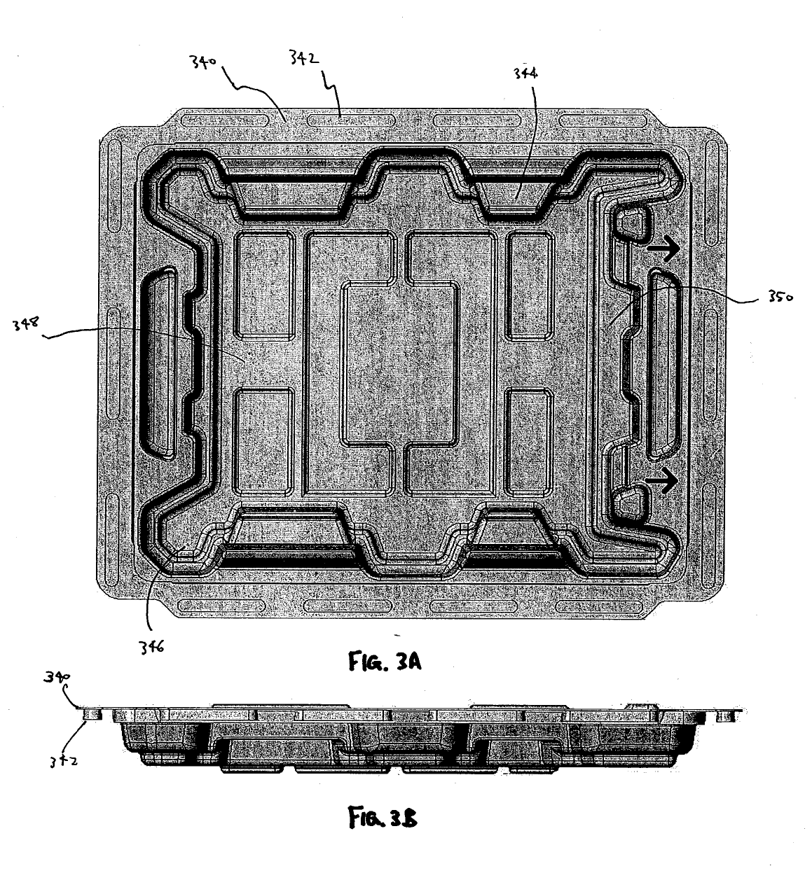

FIG. 3A is a plan view and FIG. 3B is a side view of the lid 104 in accordance with one embodiment of the present invention. The lid 104 can include a lip 340 along the periphery of the lid 104 and a raised top 348. As described above, the lid lip 340 can include female snaps 342 and/or male snaps for mating with female and/or male snaps of the tray 102. As with the tray 102, the lid 104 need not include a lip 340. The raised top 348 further includes at least one support structure 344 on each side of the tray 102 that contact the braces 106, 108 when the lid is connected with the tray 102. The at least one support structure 344 can include a ledge 350 so that the at least one support structure 344 checks shifting of the braces 106, 108, thereby preventing the braces 106, 108 from becoming dislodged from the circuit board. When a load is applied to the lid 104, the load is transferred to the braces 106, 108. Shocks and/or vibrations applied to the lid 104, for example during shipping, can be absorbed by the braces 106, 108 which prevent contact with electrical and/or mechanical components connected with the circuit board.

The raised top 348 of the lid 104 can further be shaped such that features of the top coincide with features of the tray 102, thus multiple bracing systems 100 can be stacked on one another such that the bracing systems 100 resist moving relative to one another.

The tray 102 and lid 104 can comprise high density polyethylene (HDPE), which provides resiliency for shock and vibration absorption. Alternatively, the tray 102 and lid 104 can comprise any thermoformable plastic. For example, the tray 102 and lid 104 can comprise low density polyethylene, acrylic, polystyrene, poly-carbonate, polymer grade ethylene and propylene (and other olefin polymers) etc, or a compound of two or more thermoformable plastics. The compound can further comprise non-plastic materials, such as glass for providing stiffness. In still other embodiment the tray 102 and/or lid 104 can comprise preformed paperboard or cardboard. One of ordinary skill in the art can appreciate the myriad of different materials that can be used to form the tray 102 and lid 104.

The tray 102 and lid 104 can be extruded from one or more sheets of material, or alternatively can be injection molded. The tray 102 and lid 104 can be formed such that the walls are thicker or thinner, as desired by the user. Different materials, and different wall thicknesses can result in different dampening performance. In some embodiments, it maybe desired that the tray 102 and lid 104 be comprised of different materials, or be comprised of similar materials having different thicknesses. One of ordinary skill in the art can appreciate the different configurations for the tray 102 and lid 104.

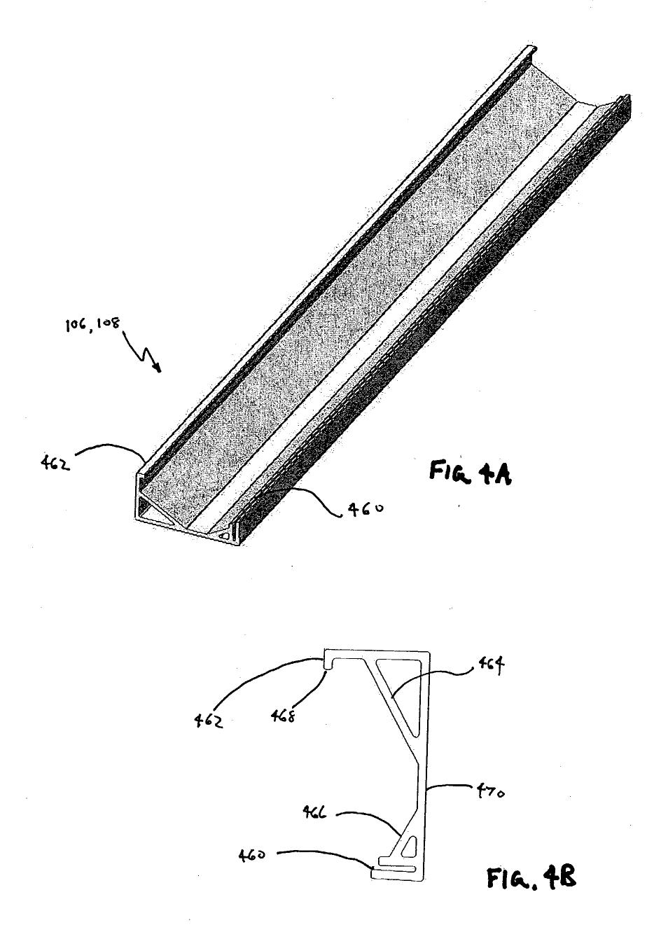

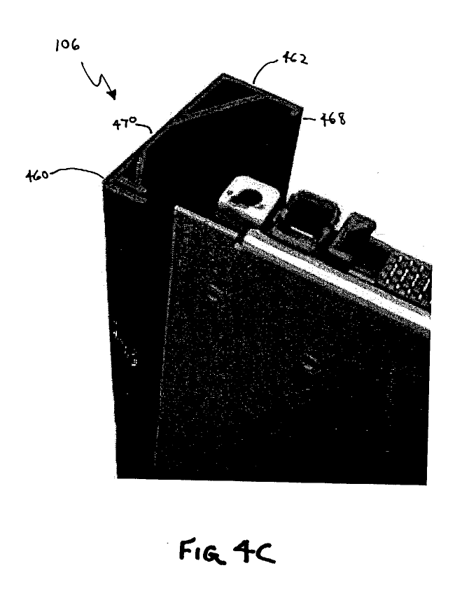

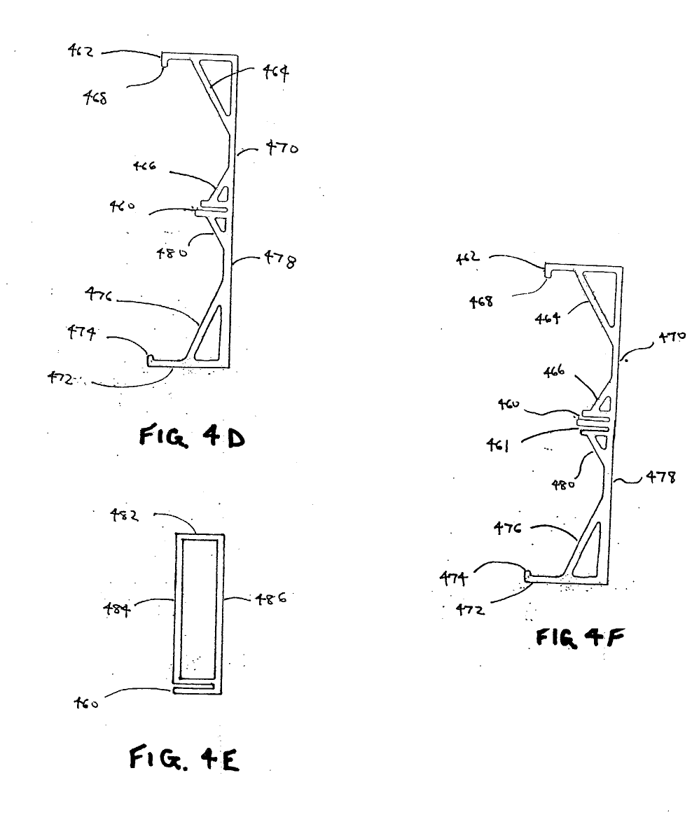

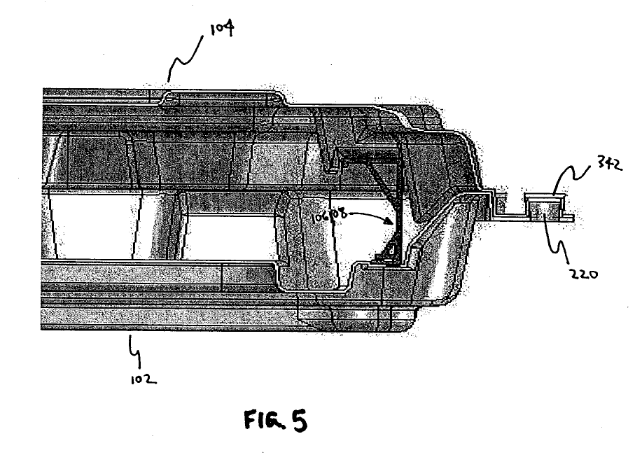

FIG. 4A is a perspective view of the brace 106, 108 of FIG. 1 for supporting a vertical load applied to the bracing system 100 in accordance with one embodiment of the present invention. Each brace 106, 108 can comprise a support surface 462 for distributing a vertical load, a clip 460 for connecting the brace 106, 108 with the circuit board, an upper compression member 464 for supporting a load applied to the support surface 462, and a lower compression member 466.

FIG. 4B is a cross-section of the brace 106, 108 of FIG. 4A. The brace 106, 108 can have a vertical height such that when the clip 460 is connected with the circuit board, the support surface 462 is positioned above electrical components and mechanical components of the circuit board. The circuit board can include electrical components such as capacitors and microprocessors, or mechanical components such as cooling fans and heat sinks. These components can protrude significantly from the circuit board. The brace 106, 108 can be customized such that the brace 106, 108 has a vertical height sufficient to position the support surface 462 above these components.

The upper compression member 464 can be connected between the support surface 462 and a vertical surface 470 of the brace 106, 108. The load applied to the support surface 464 can create a bending moment at the junction of the support surface 462 and the vertical surface 470. The width of the support surface 462 can be optimized so that the load provides a substantially compressive force to the compression member 464. The compression member 464 resists the bending moment and redistributes the load. The support structure 462 can further include a brace ledge 468. The brace ledge 468 contacts the lid ledge 350, preventing the brace from shifting in place.

The clasp 460 can comprise a slot having an opening that approximates the thickness of the circuit board or a metal backplate connected with the circuit board. As shown in FIG. 4C, the brace 106, 108 can be connected with the circuit board by sliding the lateral edge of the metal backplate of the circuit board into the slot of the clasp 460. A second compression member 466 can be connected between the vertical surface 470 and the clasp 460, and can resist a bending moment about the junction of the clasp 460 and the vertical surface 470. In other embodiments, the clasp 460 can have a hinge so that the clasp 460 can be adjusted to accommodate different thicknesses of circuit boards and/or metal backplates. In still other embodiments, the clasp can have protuberances that snap into screw-mount holes of the circuit board and/or metal backplate, thereby preventing the circuit board from shifting. In still further embodiments, the clasp can be sized to hold a larger article, for example a flat-panel display, or fragile glass, etc. One of ordinary skill in the art can appreciate the different configurations of a clasp 460 for immobilizing the circuit board.

FIG. 4D is a cross-section of an alternative embodiment of the brace 106, 108 in accordance with the present invention. The brace 106, 108 can have a second support structure below the clasp 460 having a second support surface 472, a third compression member 480 connected between the clasp 460 and an extended vertical surface 478, and a fourth compression member 476 connected between the extended vertical surface 478 and the second support surface 472, such that the circuit board is suspended above the second support structure, thereby protecting components that can be connected with the opposite side of the circuit board. The second support structure can mirror the first support structure, or can have a different geometry. For example, the extended vertical surface 478 can have a smaller dimension than the first vertical surface 470.

In still other embodiments, the brace 106, 108 can have a rectangular cross-section. As shown in FIG. 4E, the brace can have two vertical surfaces 484, 486 for distributing the compressive forces resulting when a vertical load is applied to the support surface 482. In other embodiments, the brace 106, 108 can have a circular, or elliptical cross-section. One of ordinary skill in the art can appreciate the myriad of different load-bearing configurations for the brace 106, 108.

Where it is desired that multiple circuit boards can be contained in a package, a brace 106, 108 can be used having multiple clasps. Once such brace 106, 108 is shown in FIG. 4E, and can include a structure similar to the brace 106, 108 shown in FIGS. 4A and 4D. The brace 106, 108 further includes a second clasp 461, so that a second circuit board can be connected with each brace 106, 108 such that the metal backplate of the first circuit board opposes a metal backplate of the second circuit board. The brace 406, 408 can have bracket-type compression members, as shown in FIGS. 4A and 4D for distributing a load, or alternatively can have vertical compression members, as shown in FIG. 4E. Alternatively, the compression members can have a circular or elliptical cross-section, or some other geometry.

The brace 106, 108 can comprise twenty-percent glass-filled poly-carbonate, which provides increased flex modulus, allowing the vertical surfaces 484 and support surfaces 462 of the brace 106, 108 to be made thinner. Alternatively, the brace 106, 108 can comprise a glass-filled poly-carbonate having a different percentage of glass. In other embodiments, the brace 106, 108 can comprise glass-filled acrylonitrile butadiene styrene (ABS). In still other embodiments, the brace 106, 108 can comprise any thermoformable plastic, for example polyethylene, acrylic, polystyrene, poly-carbonate, polymer grade ethylene and propylene (and other olefin polymers), etch, or a compound of two or more thermoformable plastics. The compound can further comprise non-plastic materials, such as glass for providing stiffness.

The brace 106, 108 can be melt extruded in a single piece have a variable length, allowing the brace 106, 108 to be cut to a desired length, or alternatively the brace 106, 108 can be injection molded. The flexibility in manufacturing the brace 106, 108 can provide an advantage in that a single brace design can be utilized for circuit boards having a variety of different shapes and sizes.

FIG. 5 is a partial cross-section of the bracing system of FIG. 1 showing the assembled bracing system without an article. As can be seen, the tray 102 is connected with the lid 104 by press-fitting male snaps 220 of the tray 102 into female snaps 342 of the lid 104. The braces 106, 108 lock into place between the tray 102 and the lid 104, with the brace ledge 468 contacting the lid ledge 350 such that the brace is immobilized and cannot pivot forward and collapse in response to a lateral shock and/or vibration. As can further be seen, when a load is applied, the brace is compressed and dampens at least the vertical loads applied to the bracing system, while the collapsible structures of the tray 102 and lid 104 can dampen at least the lateral loads applied to the bracing system.

A method for packaging circuit boards in accordance with one embodiment of the present invention includes connecting a brace 106, 108 with a circuit board by sliding the slot of the clasp 460 onto an edge of a metal backplate connected with the circuit board such that the support surface of the braces 106, 108 are above components of the circuit board. The circuit board and braces 106, 108 are placed in the tray 102 such that corners of a front bezel of the circuit board rest on the corners 226 of the front portion of the tray 102, braced by one or more step structures 230, with the braces 106, 108 being supported by at least one lateral step structure 232. The lid 104 can then be connected with the tray 102 such that an at least one support structure 344 locks the braces 106, 108 in place, by press-fitting the snaps of the tray 102 into the snaps of the lid 104.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

What is claimed:

1. A bracing system for packaging a circuit board, comprising:
a first brace removably connectable with a first side of the circuit board;
a second brace removably connectable with a second side of the circuit board;
a tray, including:
at least one lateral structure for supporting the first brace; and
at least one lateral structure for supporting the second brace;
wherein the circuit board is suspended over a bottom of the tray; and
a lid connected with the tray such that the first and second brace are immobilized.

2. The bracing system of claim 1, wherein the first and second brace each comprise:
a support surface adapted for bearing a load;
a vertical member connected with the support surface and adapted for positioning the support surface above the circuit board;
a first bracket connected between the support surface and the vertical member;
a clasp connected with the vertical member adapted for receiving the circuit board; and
a second bracket connected between the clasp and the vertical member.

3. The bracing system of claim 1, wherein the first and second brace each comprise:
a support surface having a first end and a second end, the support surface being adapted for bearing a load;
a first vertical member connected with the first end;
a second vertical member connected with the second end;
a clasp connected between the first end and second end.

4. The bracing system of claim 1, wherein the first and second brace each comprise:
a vertical member having a first end and a second end;
a first support surface connected with the first end and adapted for bearing a load;
a first bracket connected between the first support surface and the vertical member;
a clasp connected with the vertical member and adapted for receiving the circuit board;
a second bracket connected between the clasp and the vertical member;
a second support surface connected with the second end and adapted for bearing a load;
a third bracket connected between the second support surface and the vertical member; and
a fourth bracket connected between the clasp and the vertical member.

5. The bracing system of claim 4, wherein the first and second brace each further comprise:
a second clasp connected with the vertical member.

6. The bracing system of claim 1, wherein the first and second brace comprise glass-filled poly-carbonate.

7. The bracing system of claim 1, wherein the first and second brace comprise at least one of poly-carbonate, polyethylene, acrylonitrile butadiene styrene, ethylene, and propylene.

8. The bracing system of claim 1, wherein the tray further includes:
at least one front support structure adapted for supporting a bezel of the circuit board;
at least one front positioning structure adapted for resisting forward movement of the circuit board; and
at least one transverse collapsible structure.

9. The bracing system of claim 8, wherein the tray further includes:
a lip having at least one snap adapted for connecting the tray with the lid.

10. The bracing system of claim 1, wherein the tray comprises high-density polyethylene.

11. The bracing system of claim 1, wherein the tray comprises at least one of poly-carbonate, polyethylene, acrylonitrile butadiene styrene, ethylene, and propylene.

12. The bracing system of claim 1, wherein the lid includes:
at least one lateral support structure adapted to contact the first brace; and
at least one lateral support structure adapted to contact the second brace.

13. The bracing system of claim 12, wherein the lid further includes:
a lip having at least one snap adapted for connecting the tray with the lid.

14. The bracing system of claim 13, wherein the lid further includes:
at least one roof structure adapted to mate with a bottom of the tray of a second bracing system.

15. The bracing system of claim 1, wherein the lid comprises high-density polyethylene.

16. The bracing system of claim 1, wherein the lid comprises at least one of poly-carbonate, polyethylene, acrylonitrile butadiene styrene, ethylene, and propylene.

17. A bracing system for packaging an article, comprising:
a first brace removably connectable with a first side of the article, the first brace including:
a vertical member having a first end and a second end;
a support surface connected with the first end;
a first bracket connected between the support surface and the vertical member;
a clasp connected with the second end; and
a second bracket connected between the clasp and the vertical member;
a second brace removably connectable with a second side of the circuit board, the second brace including:
a vertical member having a first end and a second end;
a support surface connected with the first end;
a first bracket connected between the support surface and the vertical member;
a clasp connected with the second end; and
a second bracket connected between the clasp and the vertical member;
a tray, including:
at least one lateral structure for supporting the first brace; and
at least one lateral structure for supporting the second brace; and
a lid connected with the tray such that the first and second brace are immobilized.

18. A brace comprising:
a vertical member having a first end and a second end;
a support surface connected with the first end;
a first bracket connected between the support surface and the vertical member;
a clasp connected with the second end; and
a second bracket connected between the clasp and the vertical member;

19. The brace of claim 18, further comprising:
a ledge connected with the support surface.

20. A method for packaging a circuit board, comprising:
connecting a first brace with a first side of the circuit board;
connecting a second brace with a second side of the circuit board;
placing the circuit board in a tray such that circuit board is suspended over a bottom of the tray; and
connecting a lid with the tray such that the lid prevents the board from shifting.
